(19) United States
(12) Patent Application Publication
(10) Pub. No.: US 2026/0054935 A1
(43) Pub. Date: Feb. 26, 2026

(54) EXPANDED CAPACITY AUTOCLAVE

(71) Applicant: Wichita State University, Wichita, KS (US)

(72) Inventors: Brian Clothier, Wichita, KS (US); Joshua Goertz, Wichita, KS (US)

(21) Appl. No.: 19/307,006

(22) Filed: Aug. 21, 2025

Related U.S. Application Data
(60) Provisional application No. 63/685,889, filed on Aug. 22, 2024.

(51) Int. Cl. B65G 21/22; B65G 13/00

(52) U.S. Cl. CPC B65G 21/22; B65G 13/00

(57) ABSTRACT

The present disclosure provides an autoclave comprising a conveyor fixed to a floor of the autoclave, the conveyor having a length and a first edge and a second edge, wherein the conveyor comprises a plurality of rollers. The autoclave includes a first cart rail and a second cart rail fixed to the floor of the autoclave, the first cart rail and second cart rail spanning an internal length of the autoclave, wherein the first cart rail and the second cart rail are located exterior to the first and second edges of the conveyor. An autoclave cart is positioned above the conveyor on the first cart rail and the second cart rail, wherein the autoclave cart comprises an elevated platform, a frame supporting the elevated platform, and a plurality of wheels connected to the frame, wherein the plurality of wheels engages with the first cart rail and the second cart rail.

### RELATED APPLICATION

This application claims priority to US Provisional Patent Application No. 63/685,885, entitled Expanded Capacity Autoclave, filed August 22, 2024. This related application is hereby incorporated by reference in its entirety for all purposes.

### FIELD

This disclosure generally pertains to autoclaves. More specifically, this disclosure pertains to autoclave part handling systems.

### BACKGROUND

Use of large volume autoclaves is common in the aviation, automotive, and space industries. However, these large volume autoclaves have limited space for placing bagged parts for curing. These bagged parts include heavy tools, which can be difficult to move in and out of the autoclave. In the aerospace industry, composite parts are cured within an autoclave under a vacuum bag. The composite parts require temperature monitoring with thermocouples and vacuum connections to the vacuum bag or the mold the composite part is placed on. Once a mold is loaded into an autoclave, operators work in the confined space of the autoclave to connect the vacuum hoses and thermocouple wires to the work pieces. Composite cure cycles can often be lengthy, lasting multiple hours and requiring large amounts of energy consumption. Because of the long cycle times associated with autoclave cycles, and the labor required to load and unload the autoclave, it is preferable to maximize the usage of the autoclave during a single run by loading as many parts as possible. The parts on the mold, otherwise called work pieces, may be of different sizes and shapes.

### SUMMARY

In an aspect, an autoclave is disclosed herein. The autoclave comprises a conveyor, an autoclave cart, and two cart rails spanning an internal length of the autoclave. The conveyor is fixed to the floor of the autoclave and comprises a plurality rollers. The conveyor supports a first work piece and possibly multiple work pieces at the bottom level. The conveyor may contain free-spinning rollers that make it possible to load, unload and support work pieces. The use of rollers facilitates open area around the work piece for air to circulate under the work pieces during an autoclave cycle.

The autoclave includes an autoclave cart with an elevated platform and a frame to support the surface. The frame has multiple wheels so the cart may be moved in and out of the autoclave. The wheels ride upon two cart rails that are fixed to the autoclave floor. The first and second cart rails are located outside of, or exterior to the conveyor, such that the conveyor is positioned between the two rails. The autoclave cart, when loaded into the autoclave, is positioned above the conveyor. The conveyor has at least two edges; and these two outer edges may include guides to prevent work pieces from interfering with the cart rails and the movement of the autoclave cart. The autoclave cart has a height that is sufficient to make room for the first work piece to be positioned below the autoclave cart. In the case of retrofitting an existing autoclave, spacers can be provided to increase the height of the autoclave cart in order to have clearance for the work pieces being placed on the conveyor.

In an embodiment, the autoclave includes a utility extension and routing system for extending the vacuum hoses and thermocouple wires from the autoclave utility panel to the first work piece. The system includes a utility mount located near the conveyor, the utility mount receives the hoses and wires and directs them to the first work pieces on the conveyor. The hoses and wires may be routed to the back corner of the autoclave, and then branch off with sufficient length to be able to reach the first work piece.

A method of loading an autoclave is disclosed. The method involves loading a first work piece onto the conveyor. Multiple work pieces may be loaded onto the conveyor and the utilities may be connected to the bottom work pieces. A second work piece is loaded onto the autoclave cart on the substantially flat surface, multiple work pieces may be placed on the autoclave cart without departing from the scope of the disclosure. The autoclave cart with the second work pieces is moved on the first and second cart rails so that it is positioned above the conveyor and the first work piece resulting in a stacked arrangement of the work pieces. The utilities may then be installed for the second work piece. Once the work pieces are finally prepared for the autoclave run, the door of the autoclave is closed and the processing cycle begins.

In an aspect, an autoclave for manufacturing parts is disclosed. The autoclave comprises a pressure vessel having a length extending from a front end to a back end and a width extending perpendicular to the length. The pressure vessel comprises a door at the front end and a floor extending along the length and the width of the pressure vessel. The door is configured to selectively open and close the autoclave. The autoclave comprises first and second cart rails spaced apart along the width of the pressure vessel and extending lengthwise. The autoclave comprises a conveyor supported on the floor between the cart rails. The conveyor is configured to support a part at a lower level in the pressure vessel during an autoclave process. The autoclave comprises a rolling cart comprising an elevated platform. The rolling cart is configured to be positioned on the first and second cart rails such that the elevated platform is spaced apart above the conveyor. The elevated platform is configured to support one or more parts at an upper level in the pressure vessel during the autoclave process. The rolling cart is configured so that parts can be simultaneously supported on the elevated platform at the upper level and on the conveyor at the lower level below the elevated platform during a same autoclave process.

In another aspect, a method of loading an autoclave is disclosed. The method comprises loading a first work piece into an autoclave between first and second cart rails extending lengthwise in the autoclave. The method comprises loading a second work piece onto a rolling cart, the rolling cart comprising an elevated platform, a frame supporting the elevated platform, and a plurality of wheels connected to the frame. The method comprises moving the rolling cart with the second work piece onto the first and second cart rails, wherein the plurality of wheels on the rolling cart are guided by the first and second cart rails. The method comprises positioning the rolling cart so that the second work piece is above the first work piece to create a stacked arrangement of work pieces for simultaneous processing during an autoclave cycle.

In another aspect, an autoclave modification kit to expand a work piece processing capacity of an autoclave is disclosed. The autoclave modification kit comprises a plurality of spacers, wherein the plurality of spacers are configured to increase a height of a rolling cart to provide clearance for work pieces positioned below the rolling cart. The autoclave modification kit comprises a roller conveyor having a length, a first edge, and a second edge, the roller conveyor comprising a plurality of free-spinning rollers configured to be fixed to a floor of the autoclave between first and second cart rails. The autoclave modification kit comprises a plurality of guides, the guides configured to be mounted on the first edge and the second edge of the roller conveyor to contain work pieces within a contained width that is inwardly spaced from the first and second cart rails.

Other aspects will be in part apparent and in part pointed out hereinafter.

### BRIEF DESCRIPTION OF THE DRAWINGS

FIG. 1 is a schematic of a prior art autoclave without expanded capacity;

FIG. 2 is a schematic of an exemplary embodiment of an autoclave of the present disclosure;

FIG. 2A is a cross-sectional view of the autoclave taken along line 2A-2A shown in FIG. 2 with utilities directed to the first work piece;

FIG. 3 is an exemplary embodiment of the autoclave of FIG. 2 loaded with an autoclave cart;

FIG. 3A is a cross-sectional view of the autoclave taken along line 3A-3A shown in FIG. 3 with utilities directed to the second work piece;

FIG. 4 is a perspective view of an autoclave cart outside of the autoclave on a transfer cart;

FIG. 5 is a perspective view of a secondary loading cart;

FIG. 6 is a flowchart illustrating a method of loading an autoclave.

Corresponding parts are given corresponding reference characters throughout the drawings.

### DETAILED DESCRIPTION

The aviation, automotive, and various other industries are increasingly relying on large-volume autoclaves for curing and processing applications. However, these large volume autoclaves don't provide part handling systems for layering the parts vertically for higher capacity cure cycles. The work pieces often include bagged parts on heavy molds which are difficult to maneuver in a confined space. Moving the molds in and out of the autoclave can be a cumbersome and dangerous process for operators. Connecting instrumentation and utilities to the work pieces often requires the operators to adopt awkward body positions, thereby increasing strain and fall risk. Not only does this pose a risk to the operator, but poor work piece handling and preparation can lead to bag failures which may necessitate repair or scrapping the part. A robust part handling system can protect workers and facilitate production of high quality parts.

Existing autoclave systems are limited in their ability to efficiently utilize the available processing space within the autoclave when processing multiple work pieces. This constraint necessitates the development of a solution to increase autoclave capacity while maintaining the flexibility to run different types of work pieces. An autoclave system would be easy to use with standard loading, unloading and work piece preparation procedures for the autoclave cycle. It is desirable for the system to utilize a permanent installation, eliminating the need for repeated setup and breakdown between different production volumes. In exemplary embodiments, the system could accommodate different volumes of work pieces without being obtrusive or inconvenient for the operators.

It should be noted that use of the terms "part", "mold", and "work piece", including their corresponding plural nouns, within the present disclosure may be used interchangeably and should not be interpreted as limiting, as each term represents an item which is suitable for placement within an autoclave during an autoclave processing cycle.

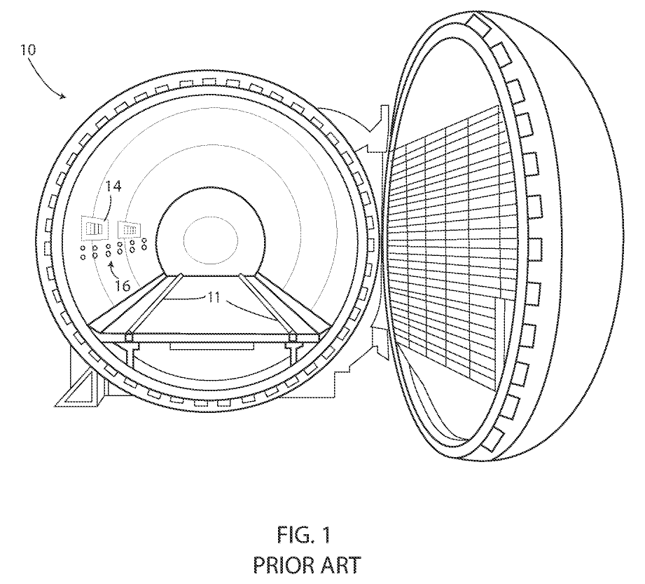

Referring to FIG. 1, an exemplary prior art autoclave without expanded capacity is shown generally at reference number 10. The autoclave 10 broadly comprises a pressure vessel having a length extending from a front end to a back end and a width extending perpendicular to the length. A door is located at the front end of the pressure vessel, and a floor 48 extends in a plane parallel to the length and width of the pressure vessel. The door is configured to selectively open and close the autoclave 10. On the floor 48, the autoclave 10 comprises two cart rails 11 spaced apart along the width and extending lengthwise. As is known to those skilled in the art, an autoclave cart (not shown) may be rolled into and out of the autoclave on the cart rails 11. On the interior of the pressure vessel side wall, the autoclave comprises thermocouple jack panels 14 and a plurality of vacuum ports 16. In this prior art autoclave configuration, the autoclave 10 may only process a work piece if the work piece is positioned atop the autoclave cart (not shown). A work piece is put on top of the autoclave cart (not shown), and the cart rides on the rails 11 to load and unload work pieces. The autoclave cart 40 remains in the autoclave 10 during the autoclave cycle.

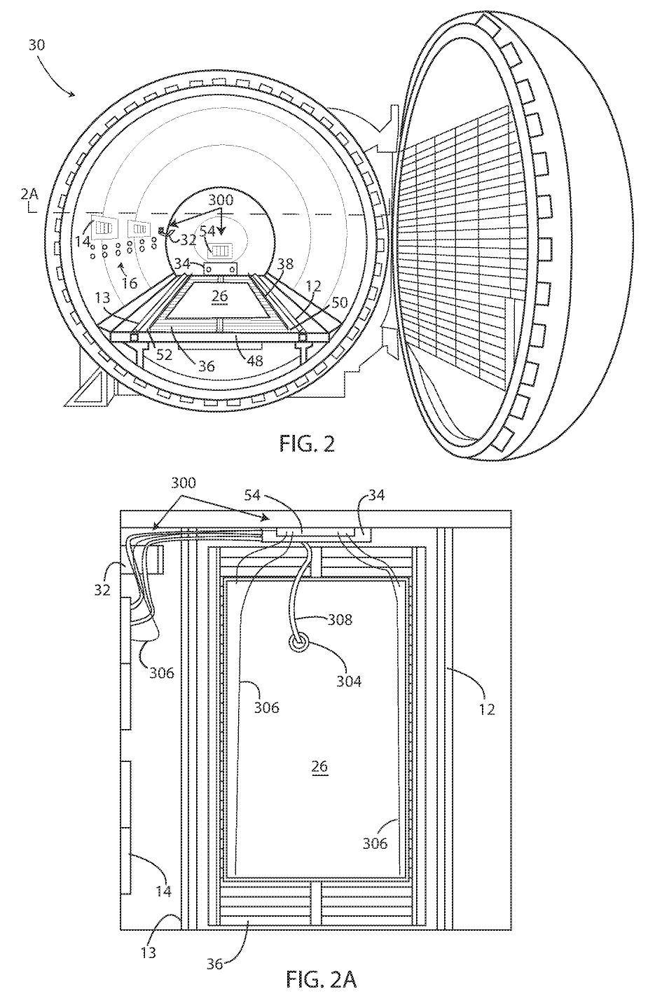

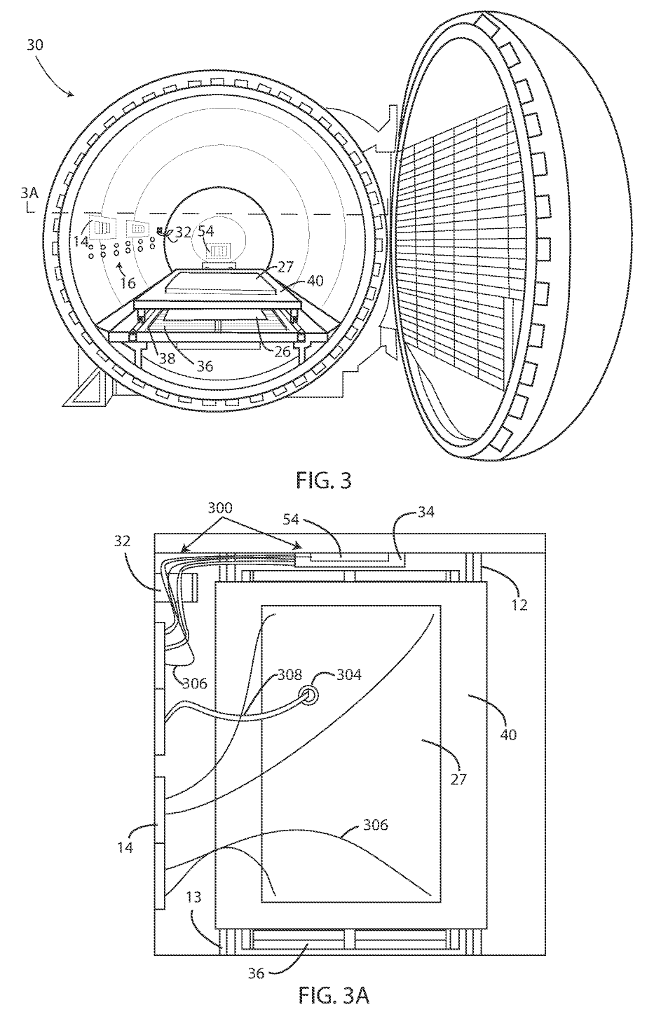

Referring to FIGS. 2 and 3, an exemplary embodiment of an autoclave with expanded capacity in accordance with the present disclosure is generally indicated at reference number 30. The autoclave 30 is a modified version of the autoclave 10. And thus like the autoclave 10, the autoclave 30 comprises a pressure vessel having a length extending from a front end to a back end and a width extending perpendicular to the length, a door located at the front end of the pressure vessel configured to selectively open and close the autoclave 30, a floor 48 extending in a plane parallel to the length and width of the pressure vessel, and two cart rails 12, 13 on the floor 48 extending lengthwise at spaced apart locations along the width. As above, the cart rails 12, 13 are configured to support an autoclave cart 40. But in comparison with conventional autoclave carts, the autoclave cart 40 is modified to be more elevated. The illustrated autoclave 30 is further modified to support work pieces on a conveyor 36 below the autoclave cart 40. This configuration substantially expands the capacity of the autoclave 30 in comparison with the autoclave 10.

In an embodiment, the cart rails 12, 13 span substantially the entire internal length of the autoclave 30 (e.g., more than 90% of the total internal length). The cart may rest at any point on the cart rails 12, 13. The autoclave cart 40 has wheels 44 that are positioned to roll along the cart rails 12, 13. The cart rails 12, 13 and the wheels 44 interface in a way that restricts the cart 40 from veering widthwise as it rolls into and out of the autoclave 30.

The conveyor 36 is fixed to the floor 48, and is positioned between the first and second cart rails 12, 13. The conveyor 36 has a length. In the illustrated embodiment, the conveyor 36 is affixed directly to the floor 48 and is directly atop the floor 48. The length of the conveyor 36 may span the full length or most of the length of the floor 48 of the autoclave 30. It is possible that multiple conveyor units may be placed adjacent to each other (e.g., end-to-end) to build the conveyor 36. In general, the conveyor 36 is configured to allow one or more work pieces (e.g., work piece 26 in FIG. 2) to slide into and out of the autoclave 30 on the conveyor 36. Further, the conveyor 36 is configured to support one or more work pieces during an autoclave process.

The conveyor 36 includes guides 38 along opposite longitudinal edges 50, 52. The guides 38 extend lengthwise adjacent to the cart rails 12, 13 and are spaced apart inboard from the cart rails 12, 13. The guides 38 are configured to contain one or more work pieces on the conveyor 36 within a contained width that is inwardly spaced from the cart rails 12, 13, preventing work pieces from interfering with the cart rails 12, 13 or the autoclave cart 40. In an example, the guides 38 comprise vertically mounted rollers positioned to define a roller guide surface that extends in a plane oriented at an angle of approximately 90° in relation to the floor 48. If so desired, the roller guides 38 may be installed at any alternative angle which is suitable to better accommodate a work piece. The guides 38 prevent work pieces from straying outside of the boundaries of the conveyor 36 and interfering with the autoclave cart 40 or the cart rails 12, 13.

In an exemplary embodiment, the conveyor 36 is a roller conveyor. In some cases, the roller conveyor 36 has a plurality of rollers that are able to spin to facilitate sliding one or more work pieces 26 in and out of the autoclave 30. Suitably, each roller can spin on an axis of rotation extending widthwise. The rollers are suitably spaced apart to define gaps that provide for air flow around work pieces supported on the conveyor 36, which is thought to facilitate better heat transfer. In an example, the free-spinning rollers may form a dry-bearing gravity roller system, but other rollers of different types may be used without departing from the scope of the present disclosure. Further, it is within the scope of the present disclosure to include a motorized or an electric conveyor instead of the free spinning roller conveyor 36.

The autoclave 30 further comprises a utility mount 300 at the rear near the conveyor 36. In an embodiment, the utility mount 300 includes a secondary thermocouple jack panel 54, a manifold 34, and a hose bracket 32. Other types of mounts and extensions may be used to route the instrumentation and plumbing from the sidewall of the autoclave 30 to the back and lower portion of the autoclave 30. The purpose of routing the utilities this way is to prevent entangling when an autoclave cart 40 is loaded onto the cart rails 12, 13.

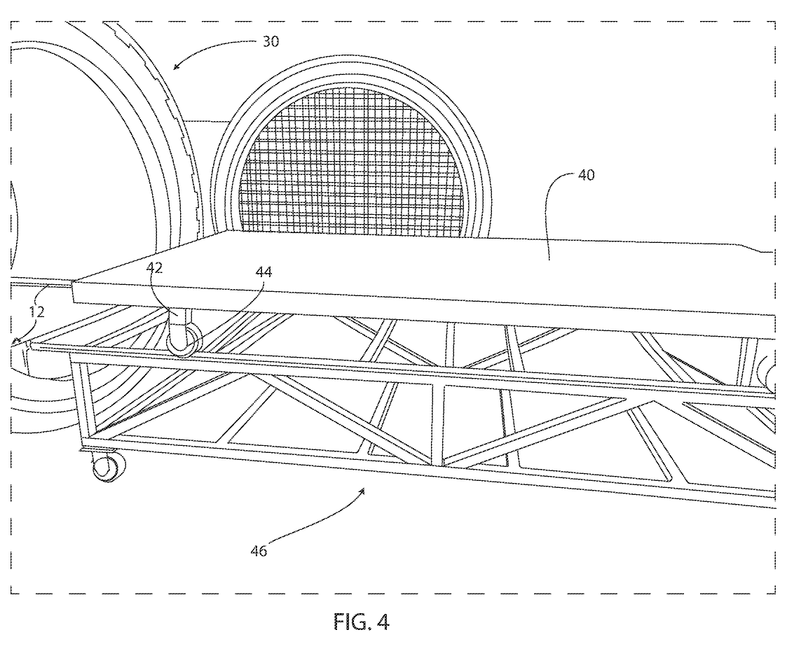

FIG. 4 depicts an exemplary autoclave cart 40 in accordance with the present disclosure. The autoclave cart 40 is a rolling cart comprising a plurality of wheels 44, a frame, and an elevated platform on top of the frame. The autoclave cart 40 is configured to support and hold a work piece during transport and during the autoclave processing cycle. The elevated platform typically has a flat top surface but can accommodate irregularly shaped parts using fixtures. For example, curved surfaces, rails, frames, or other structures can be placed on the cart's flat top to properly support and secure irregularly shaped parts during transportation and curing. Alternatively, carts with curved top surfaces can be used for curved or irregular part geometries.

In an embodiment, a plurality of spacers 42 are placed below the bottom level of the elevated platform of the autoclave cart 40, with a spacer 42 being placed directly above each of the wheels 44 of the autoclave cart 40. The plurality of spacers 42 raise the elevated platform of the autoclave cart 40, increasing the amount of vertical space beneath the cart to enable a work piece to be placed on the conveyor 36 without interfering with the autoclave cart 40. It should be noted that an autoclave cart 40 with a modified frame may alternatively be provided such that a height of the frame is sufficient to provide clearance for the lower work piece.

In an embodiment, the autoclave 30 further comprises one or more utility mounts 300 to route wires, hoses, and other instruments to the first work piece 26 on the conveyor 36. In some cases the utility mount 300 includes a secondary thermocouple jack panel 54, located at the back or the floor 48 of the autoclave 30. The secondary thermocouple jack panel 54 enables attachment of thermocouple wires 306 to the bottom work pieces placed within the autoclave 30, and it prevents the thermocouples from being run over by the wheels 44 of the autoclave cart 40, tripped over by a laborer within the autoclave 30, or intertwining with other thermocouples attached to other parts.

As seen in FIG. 2A, an exemplary embodiment of a utility mount 300 includes a vacuum hose extension system. The vacuum hose extension system includes multiple vacuum hoses 308 that connect an existing vacuum port 16 located on the sidewall of the autoclave 30 to a manifold 34 located near the conveyor 36. The manifold 34 receives the vacuum hoses 308 and directs at least one vacuum hose 308 to the work piece vacuum fitting 304. Generally, these vacuum hoses 308 are routed from the side wall of the autoclave 30 down toward the floor 48 of the autoclave 30. The utility mount 300 may further comprise a hose bracket 32 on a wall of the autoclave 30. The hose bracket 32 is configured to direct and suspend the vacuum hoses 308. During a cure cycle, if the conveyor 36 is not being used to support a part, either the existing vacuum ports 16 or the utility mount 300 may be used, according to user preference for each part being processed. It should be noted that the utility mount 300 may also be used without a manifold 34 without departing from the scope of the present disclosure. For example, at least one hose bracket 32 can be placed on any of the walls within the autoclave 30 to direct vacuum hoses 308. Further, it is possible for additional vacuum ports 16 to be added to accommodate a part on the conveyor 36.

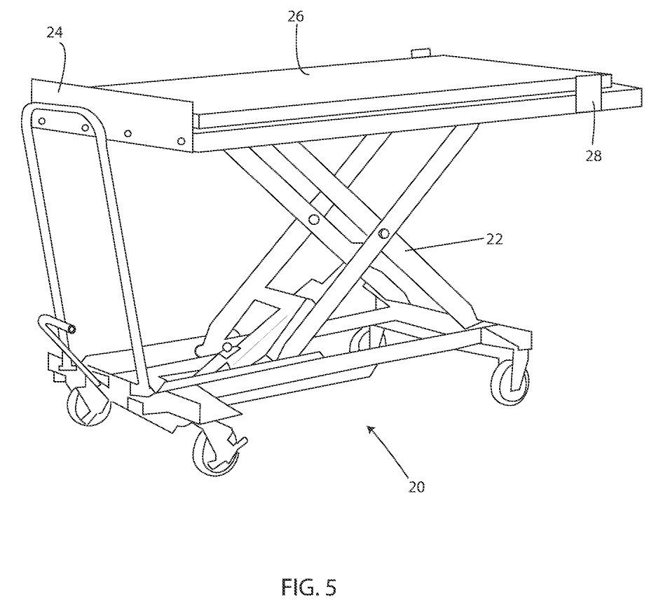

In an exemplary embodiment as depicted in FIG. 5, the autoclave 30 of the present disclosure can be used in combination with a secondary loading cart 20 including a scissor lift 22. The secondary loading cart 20 may be raised or lowered into alignment with the conveyor 36, which allows the work piece to easily slide onto the conveyor 36 into position for the autoclave processing cycle. The secondary loading cart 20 may also include locks 28 around the perimeter of the top of the cart to secure the work piece. In some embodiments, the secondary loading cart 20 further includes a back stop 24 to prevent work piece shifting during transport.

It should be noted that the autoclave 30 as described thus far can operate with both a first work piece 26 on the conveyor 36 and a second work piece 27 on the autoclave cart 40 without either part interfering with the other or interfering with the functioning of the autoclave 30. Further, the autoclave 30 is capable of operation with a single part being within the autoclave 30, either on the conveyor 36 or on the autoclave cart 40, whichever is preferred. Even when a single part is being processed within the autoclave 30, the conveyor 36 and other aforementioned elements do not need to be uninstalled.

Often, autoclave purchases include an autoclave cart 40 and cart rails 11 (FIG. 1). An autoclave modification kit may include the elements to expand the processing capacity of an autoclave. A kit within the scope of the present disclosure may include a plurality of spacers 42 to extend the height of the autoclave cart 40. The kit may also include a conveyor 36, e.g., a roller conveyor with free-spinning rollers and guides. Furthermore, the kit may include guides 38. The guides 38 may be integral to the conveyor 36 or they may be separate and subsequently mounted to the conveyor 36. It is within the scope of the present disclosure for the size of the plurality of spacers 42, the guides 38 and the conveyor 36 to be customizable to work with a specific autoclave size, industry, or application if so desired.

The autoclave modification kit may include a utility mount 300 configured to receive at least one of a vacuum hose 308 and a thermocouple wire 306 from a utility panel located on the sidewall of the autoclave 30 and direct the vacuum hose 308 and/or thermocouple wire 306 to the first work piece 26. As one skilled in the art will recall, an autoclave 10 as purchased often includes a thermocouple jack panel 14 and vacuum ports 16 located on a side wall of the autoclave 10, as shown in FIG. 1. The utility mount 300 which includes the hose extension system routes some of the utilities to the back and bottom work piece that is positioned on the conveyor 36. Using a utility mount 300 prevents entanglement of the hoses and wires directed to the bottom work piece when the autoclave cart 40 is loaded into autoclave 10.

In yet another aspect, a method of loading an autoclave 30 is disclosed. A first work piece 26 may be loaded on a top surface of a secondary loading cart 20. The secondary loading cart 20 has a flat surface to support the first work piece 26 and is also modified with locks 28 around the perimeter of the top surface to secure the work piece. The first work piece 26 is loaded onto the secondary loading cart 20 from a work surface by adjusting the height of the secondary loading cart 20 such that the top surface is level with the work surface and sliding the work piece atop the cart. Next, the secondary loading cart 20 is rolled to the entrance of the autoclave 30, and the height of the scissor lift 22 is adjusted such that the bottom of the work piece is level with the top of the conveyor 36.

In an embodiment, a portion of the secondary loading cart 20 may be removably coupled to the autoclave 30 in order to prevent unnecessary movement while transferring the work piece from the secondary loading cart 20 into the autoclave 30. If the work piece was secured atop the scissor cart 20 by a plurality of locks 28, these locks 28 are released and the work piece is then loaded onto the conveyor 36. The secondary loading cart 20 is then removed from the entrance of the autoclave 30.

With reference now to the loading of the second work piece 27 onto the autoclave cart 40, in an embodiment the autoclave cart 40 is positioned on top of a transfer cart 46 as shown in FIG. 4. A second work piece 27 may be loaded onto the autoclave cart 40 and then the transfer cart 46 transports the autoclave cart 40 to the autoclave 30. The top surface of the transfer cart 46 in some embodiments has a plurality of cart rails for stabilizing the autoclave cart wheels 44 during transport. The transfer cart 46 is configured to have a height which enables the cart rails atop the transfer cart 46 to align with cart rails 12, 13 within the autoclave 30. The transfer cart 46 is rolled to the entrance of the autoclave 30 and is temporarily fixed to the autoclave 30 such that the transfer cart 46 does not move. The autoclave cart 40 is then rolled from the cart rails of the transfer cart 46 onto the cart rails 12, 13 within the autoclave 30.

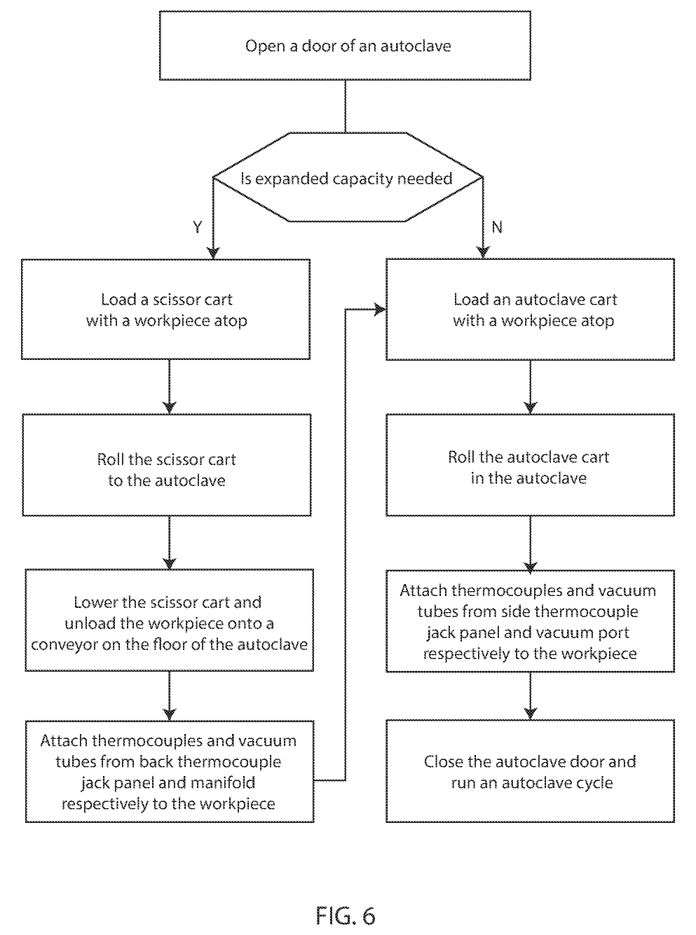

FIG. 6 depicts an exemplary embodiment of the method of the current disclosure. The method as outlined in the figure begins with opening a door of an autoclave 30, and evaluating if expanded capacity is desired for the autoclave processing cycle. If expanded capacity is not required, an autoclave cart 40 is loaded with a work piece before being rolled into the autoclave 30. Thermocouples and vacuum hoses are then attached to the work piece before the autoclave door is closed and an autoclave processing cycle is run.

If expanded capacity is desired, however, the method begins with a scissor cart 20 being loaded with a work piece atop it, then the scissor cart 20 is rolled up to the entrance of the autoclave 30. The height of the scissor cart 20 is then adjusted suitable for the bottom of the work piece to be in alignment with the top of the floor conveyor. In the example method of FIG. 6, the scissor cart 20 is lowered for alignment.

The work piece atop the scissor cart 20 is then unloaded onto the floor conveyor before thermocouples and vacuum hoses are extended from the thermocouple jack panels 14, 54 and manifold 34 to the work piece. After each of these steps is completed, the method continues with loading a second work piece 27 atop an autoclave cart 40, rolling the autoclave cart 40 into the autoclave 30, attaching thermocouples and vacuum hoses to the work piece, and then closing the autoclave door for the commencement of the autoclave processing cycle.

When introducing elements of the present disclosure or the preferred embodiment(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. An autoclave for manufacturing parts, the autoclave comprising:
a pressure vessel having a length extending from a front end to a back end and a width extending perpendicular to the length, the pressure vessel comprising a door at the front end and a floor extending along the length and the width of the pressure vessel, the door configured to selectively open and close the autoclave;
first and second cart rails spaced apart along the width of the pressure vessel and extending lengthwise; a
conveyor supported on the floor between the cart rails, the conveyor configured to support a part at a lower level in the pressure vessel during an autoclave process; and
a rolling cart comprising an elevated platform, the rolling cart configured to be positioned on the first and second cart rails such that the elevated platform is spaced apart above the conveyor, the elevated platform configured to support one or more parts at an upper level in the pressure vessel during the autoclave process, wherein the rolling cart is configured so that parts can be simultaneously supported on the elevated platform at the upper level and on the conveyor at the lower level below the elevated platform during a same autoclave process.

2. The autoclave of claim 1, wherein the conveyor comprises a roller conveyor having a plurality of free-spinning rollers configured to facilitate sliding parts into and out of the autoclave.

3. The autoclave of claim 1, wherein the conveyor comprises guides positioned along opposite longitudinal edges of the conveyor, the guides being inboard of the first and second cart rails and configured to laterally contain parts on the conveyor within a contained width that is inwardly spaced from the cart rails.

4. The autoclave of claim 3, wherein the guides comprise vertically mounted rollers positioned to define a roller guide surface that extends in a plane oriented at an angle in relation to the floor.

5. The autoclave of claim 1, wherein the conveyor is fixed directly to the floor of the pressure vessel and comprises a plurality of rollers spaced apart to define gaps that provide for air flow around parts supported on the conveyor.

6. The autoclave of claim 1, further comprising at least one utility mount configured to receive at least one of a vacuum hose and a thermocouple wire from a utility panel located on a sidewall of the pressure vessel and operatively connect the at least one of a vacuum hose and a thermocouple wire to a part located on the conveyor.

7. The autoclave of claim 6, wherein the utility mount comprises a secondary thermocouple jack panel located at a back portion of the pressure vessel.

8. The autoclave of claim 6, wherein the utility mount comprises a manifold configured to receive vacuum hoses and direct at least one vacuum hose to a part vacuum fitting.

9. The autoclave of claim 1, wherein the rolling cart comprises a plurality of spacers positioned below the elevated platform to increase a height of the elevated platform to provide clearance for parts positioned on the conveyor.

10. The autoclave of claim 1, wherein the conveyor spans substantially an entire internal length of the pressure vessel and is fixed directly to the floor.

11. A method of loading an autoclave, the method comprising:
loading a first work piece into an autoclave between first and second cart rails extending lengthwise in the autoclave;
loading a second work piece onto a rolling cart, the rolling cart comprising; an elevated platform;
a frame supporting the elevated platform; and
a plurality of wheels connected to the frame; moving the rolling cart with the second work piece onto the first and second cart rails, wherein the plurality of wheels on the rolling cart are guided by the first and second cart rails;
positioning the rolling cart so that the second work piece is above the first work piece to create a stacked arrangement of work pieces for simultaneous processing during an autoclave cycle.

12. The method of claim 11, wherein said loading the first work piece comprises placing the first work piece on a conveyor fixed to a floor of the autoclave.

13. The method of claim 12, further comprising loading the first work piece onto a secondary loading cart, adjusting a height of the secondary loading cart to align with the conveyor, and sliding the first work piece from the secondary loading cart onto the conveyor.

14. The method of claim 11, further comprising connecting utilities to the first work piece before loading the second work piece into the autoclave.

15. The method of claim 14, wherein connecting utilities to the first work piece comprises routing vacuum hoses and thermocouple wires from a utility mount located near the roller conveyor to the first work piece.

16. The method of claim 14, further comprising connecting utilities to the second work piece after loading the second work piece into the autoclave.

17. The method of claim 11, further comprising positioning the rolling cart on a transfer cart, loading the second work piece onto the rolling cart while on the transfer cart, and transferring the rolling cart from the transfer cart to the first and second cart rails of the autoclave.

18. An autoclave modification kit to expand a work piece processing capacity of an autoclave, the autoclave modification kit comprising:
a plurality of spacers, wherein the plurality of spacers are configured to increase a height of a rolling cart to provide clearance for work pieces positioned below the rolling cart;
a roller conveyor having a length, a first edge, and a second edge, the roller conveyor comprising a plurality of free-spinning rollers configured to be fixed to a floor of the autoclave between first and second cart rails; and
a plurality of guides, the guides configured to be mounted on the first edge and the second edge of the roller conveyor to contain work pieces within a contained width that is inwardly spaced from the first and second cart rails.

19. The autoclave modification kit of claim 18, further comprising a utility mount configured to receive at least one of a vacuum hose and a thermocouple wire from a utility panel located on a sidewall of the autoclave and direct the at least one of a vacuum hose and a thermocouple wire to a work piece positioned on the roller conveyor.

20. The autoclave modification kit of claim 19, wherein the utility mount comprises a secondary thermocouple jack panel and a manifold configured to be installed at a back portion of the autoclave to route utilities to work pieces positioned on the roller conveyor without interfering with the movement of the rolling cart.
